(19) United States
(12) Patent Application Publication
(10) Pub. No.: US 2011/0233181 A1
(43) Pub. Date: Sep. 29, 2011

(54) ELECTRICAL HEATING DEVICE

(75) Inventors: Holger Reiss, Rheinzabern (DE); Benjamin Pannier, Karlsruhe (DE)

(73) Assignee: Eberspacher catem GmbH & Co. KG, Herxheim (DE)

(21) Appl. No.: 13/039,578

(22) Filed: Mar. 3, 2011

(30) Foreign Application Priority Data
Mar. 26, 2010 (EP) 10003262.2

(51) Int. Cl. B60L 1/02

(52) U.S. Cl. 219/202

(57) ABSTRACT

The present invention relates to an electrical heating device for motor vehicles, in particular with electrical propulsion. Through a readjustment based on a comparison of set and actual values, the power is adapted to a specified power demand under continuously changing operating conditions. For this purpose, the total current passing through the heating device is measured, for example with a Hall sensor, and the momentary power consumption (actual value) determined by multiplication with the specified on-board electrical voltage.

### BACKGROUND OF THE INVENTION

1. Field of the Invention

The present invention relates to an electrical heating device for a motor vehicle. The present invention particularly relates to an electrical heating device which is especially suitable for a motor vehicle the drive unit of which does not produce sufficient waste heat for the heating nor for the air conditioning of the vehicle passenger compartment. This is the case for example with vehicles with an electrical or hybrid drive.

2. Description of the Related Art

An appropriate heating device must therefore be suitable for providing both the interior of the motor vehicle with the required thermal heat as well as making heat available for the running processes in the individual system parts of the motor vehicle or at least providing this demanded heat, such as for example for preheating the vehicle rechargeable battery.

In the state of the art it is known that so-called resistance heating elements or PTC (positive temperature coefficient) heating elements can be used for this purpose. They are self-regulating, because they exhibit a higher resistance with increasing heating, thus allowing a lower amount of current to flow for the same voltage. The self-regulating properties of the PTC heating elements thus prevent overheating.

Accordingly PTC heating elements are often used in radiators which are particularly used for heating the vehicle passenger compartment in vehicles of this nature, the drive of which does not produce sufficient process heat for the air conditioning or heating of the vehicle passenger compartment. With hybrid vehicles a PTC heating device can also be used as an auxiliary heater in the phases in which the internal combustion engine is not running (for example at traffic lights or in a traffic jam).

The air in the vehicle passenger compartment is heated with the aid of the PTC resistance heating elements either directly (air heater) or indirectly via a hot water circuit in which hot water flows through radiators (hot water heating). In both cases a flowing fluid, i.e. a liquid or gaseous medium, preferably water or air, is directly heated by the heating elements.

An example of an electrical PTC heater with a plurality of heating elements for a motor vehicle is known from DE 198 45 401 A1. The heating power of one heating element can be continuously adjusted with a PWM control whereas for all other heating elements it can only be switched off or on completely in a binary manner.

With a motor vehicle heating device it is desirable, also under continually changing ambient and operating conditions (in particular on-board electrical voltage as well as temperature and flow velocity of the fluid) to match the heating power of an electrical heating device as accurately as possible to a power specification.

With PTC resistance heating elements there is in this respect a problem of the pronounced dependence of the behaviour of a PTC on the ambient and operating conditions in the automotive high voltage range, i.e. in the range of a few hundred volts. This particularly relates to vehicles with an electrical drive, because with these the on-board electrical voltage may be up to 500 volts and thus—from an automotive standpoint—it lies in the high voltage range.

A controller only based on nominal conditions (fixed on-board electrical voltage and, for example, 0° C. air temperature with a certain flow velocity for an air heater), which at low voltages (in the automotive low voltage range of, for example, approx. 12 V or approx. 24 V) still provides usable results, is thus inadequate for precise conformance to power requirements in the automotive high voltage range.

Particularly in the high voltage range variations in the on-board electrical voltage U have a pronounced effect. With 12 V on-board supply systems a voltage variation (for example up to 12.5 V) only plays a minor role for the heating power. Decisive for the power P=U×I is essentially the current I (substantially higher than in the automotive high voltage range). This is different, for example, with a 350 V or 400 V on-board supply system. Normal voltage variations of approx. +/−50 V in this range with low currents I have a significant effect on the heating power obtained. In addition, with the materials used for PTC heating elements (for example similar to ceramics based on barium titanate) in the automotive high voltage range there is a semiconductor effect, according to which the resistance is not just temperature-dependent, but also voltage-dependent.

Since PTC resistances are heavily dependent on the temperature, it must also be considered in the control of the electrical heating that the ambient temperatures (temperatures of the flowing medium) and flow velocities are subject to changes or variations, because these parameters decisively affect the production of thermal heat and thus the operating temperature of the heater element.

A precisely operating power controller for a PTC based heating device in the automotive high voltage range must therefore be able to compensate varying ambient temperatures and changing operating conditions.

### SUMMARY OF THE INVENTION

The object of the present invention is to provide an electrical heating device for a motor vehicle and a control method for an electrical heating device with which the heating power can be adapted to a specified power demand even under varying ambient and operating conditions and the adaptation can be maintained over time.

According to a first aspect of the present invention, an electrical heating device for a motor vehicle such as a vehicle electrical propulsion, is provided. The heating device comprises a control device for adjusting a heating power by adjusting the heating current flowing through the heating device. The heating device further comprises a device for measuring the total heating current. Furthermore, the heating device has a calculation device for calculating a momentary heating power from the measured total heating current and an on-board electrical voltage of the motor vehicle. The heating power to be adjusted by the control device is readjusted based on the momentary heating power and a set value.

According to a second aspect of the invention, a method for the control of an electrical heating device for a motor vehicle is provided in which the heating power is adjusted by adjusting the heating current flowing through the heating device. The method further comprises the step of measuring the total heating current. Furthermore, the method comprises the steps of calculating a momentary heating power from the measured total heating current and an on-board electrical voltage of the motor vehicle and readjusting the heating power to be adjusted based on the momentary heating power and a set value.

The particular approach of the present invention is to adapt a preliminarily adjusted heating power of a heating device for motor vehicles, for example based on defined nominal conditions for the ambient and operating parameters, to a specified power demand in a following closed-loop control circuit. For this purpose the total heating current is continuously measured. The determination of the momentary heating power of the heating device is based on this taking into account the on-board electrical voltage. The readjustment takes place based on the deviation of the momentary heating power from a set value. Thus, according to the invention an electrical heating device is controlled such that under varying ambient conditions and with heater elements with a non-linear characteristic a specified power demand can be continuously fulfilled as accurately as possible.

Preferably, a Hall sensor is used for the measurement of the total heating current. This facilitates a simple, cost-effective and robust current measurement with which problems with regard to electromagnetic compatibility (EMC) are avoided. In comparison a current measurement in the high voltage range in the motor vehicle using a shunt would lead to high interference so that no practicable measurement would be possible. In the case of a heating device for a motor vehicle with an on-board electrical voltage in the automotive high voltage range of a few hundred volts the Hall sensor is directly integrated into the control circuit in the low voltage range. Thus, the current measurement value referred to the high voltage range is immediately available for processing in the low voltage range. Furthermore, a prescribed isolation between the control circuit with the low voltage and the load circuit in the high voltage range is maintained.

According to a preferred embodiment the heating device furthermore comprises a comparator for the determination of a deviation of the momentary heating power from the set value. The readjustment occurs on this basis such that the deviation of the momentary heating power from the set value is minimised.

Preferably, the heating device comprises an electrical heating stage with at least one heating element which can be adjusted continuously or in fine steps.

According to a preferred embodiment the electrical heating device furthermore comprises one or a plurality of further electrical heating stages each with at least one heater element. The further electrical heating stages are preferably so-called binary heating stages each of which can only be switched between zero and a maximum power. The heating power of the heating elements can be separately adjusted by the control device via the current for the heating stages which flows in each case through the heating elements. A control concept of this nature facilitates a combined control with which binary heating stages are used for the control of larger power stages. A smaller heating stage is switched to continuously or fine-stepped (quasi-continuously) only for the fine adjustment. In this way, in the high voltage range with the simple control of the heating circuits (e.g. by a PWM signal) the generation of severe interference, e.g. due to EMC (electromagnetic compatibility) emissions or wire-bound interference, is avoided.

Preferably switchover of the further heating stages by the control device can be used for adaptation of the power consumption to the set value.

According to a preferred embodiment the heating device has a non-volatile memory in which the on-board electrical voltage is stored as a prescribed fixed value. Also preferably, the non-volatile memory is a programmable read only memory, preferably an EEPROM (Electrically Erasable Programmable Read Only Memory). In the EEPROM the on-board electrical voltage is saved in the software or firmware.

According to an alternative preferred embodiment the on-board electrical voltage is communicated via a communication interface of the motor vehicle as a message to the heating device. The communication interface is preferably a vehicle bus (e.g. a CAN (Controller Area Network) bus or LIN (Local Interconnect Network) bus).

According to a further alternative preferred embodiment the on-board electrical voltage is directly measured in the heating device. This preferably occurs on the circuit board, that is on the high voltage side. The measurement can take place permanently or at predetermined time intervals.

In a further preferred embodiment the heating power of a first heating stage can be adjusted in fine steps via a modulation of the current flowing through the heating element. “In fine steps” is taken to mean a step-by-step adjustment capability in a plurality of steps, whereby the number of the steps is selected such that the power differences in the first steps are small compared to the attainable total power of the heating stage. For this purpose an assignment table is stored preferably in a non-volatile memory. The non-volatile memory can furthermore be preferably integrated into a non-volatile memory in which according to a preferred embodiment the on-board electrical voltage is stored as a fixed value. In this respect an EEPROM or another programmable read-only memory in particular can be used. However, it is also possible to provide a non-volatile memory of this nature separately for the assignment table. The on-board electrical voltage can then also be made available in other ways.

In the assignment table each of a plurality of prescribed power stages (nominal power rating) is assigned a corresponding time period for the control of the heating element under a prescribed nominal on-board electrical voltage. According to an example of a preferred embodiment the total power of the first heating stage lies in the upper three-figure watt range, e.g. 750 W. However, for example 1000 W or more is also possible. In the example embodiment the number of the possible prescribed power stages in this respect lies in the upper single-figure range, e.g. 7 or 8. The control device adjusts the heating power of the finely stepped adjustable heating stage such that the corresponding time period is taken from the non-volatile memory and switches on (activates) the current through the heating stage for this time period within a fixed specified cycle frame. Accordingly, a controller operating on the PWM (Pulse Width Modulation) concept is used. According to the preferred embodiment a corresponding time period (for example in milliseconds) is directly stored in the assignment table within a specified cycle frame (fixed cycle frame). The cycle frame is a time duration (period) according to which the change of activated and not activated current is periodically repeated. Alternatively, it would also be possible, as with conventional pulse width modulation, to store a duty ratio (in %). Here, the duty ratio (mark-space ratio) specifies for which proportion of the duration of the cycle frame the current is switched on (current activated).

A control of this nature using a modified PWM with an assignment table is particularly suitable for heating elements with which the power produced increases non-linearly with the mark-space ratio, as is the case with PTC heating elements in the automotive high voltage range. In this case a simple linear power control in which the relationship of the mark-space ratio and power is identified by the value of a single proportionality factor is not possible. According to a further preferred embodiment an assignment table is therefore used in which the relationship between the time periods and the power values of the assigned power stages is non-linear. Hereby, the non-linearity of the heating element is represented in step-by-step linearised form.

As explained in the introduction, a preferred embodiment of the present invention relates to an electrical heating device for heating fluids. In this respect in the motor vehicle sector air and water heaters are preferred.

Preferably, the on-board electrical voltage lies in the automotive high voltage range, in particular in the range from 200 V to 500 V. For example, for vehicles with electrical propulsion on-board electrical voltages of about 300 V to 350 V are usual.

According to a preferred embodiment the heating elements are PTC (Positive Temperature Coefficient) heating elements.

Furthermore, the readjustment is implemented according to a preferred embodiment with the aid of a closed-loop control device which comprises a microcontroller. According to the preferred embodiment the closed-loop control is realised in the microcontroller on the low voltage side.

Further advantageous embodiments of the present invention are the subject matter of dependent claims.

### BRIEF DESCRIPTION OF THE DRAWINGS

The invention is described in the following based on the accompanying figures in which:

FIG. 1 shows an example illustration of an air heater for the automotive high voltage range with integrated electronic components;

FIG. 2 illustrates a schematic construction of a circuit board with mounted electronic control means and a power switch for a high voltage air heater with integrated electronic components;

FIG. 3 shows the schematic basic construction of an electrical heating device according to an embodiment of the invention;

FIG. 4 shows further details of the construction of an electrical heating device according to an embodiment of the invention;

FIG. 5 illustrates an example of an assignment table for the control of the first heating stage according to an embodiment of the invention; and

FIG. 6 shows an example of a finely stepped combined PWM/binary power control/power adjustment.

### DETAILED DESCRIPTION OF THE PREFERRED EMBODIMENTS

The present invention relates to an adjustable electrical motor-vehicle heater, which preferably can be formed as an air or hot water heater.

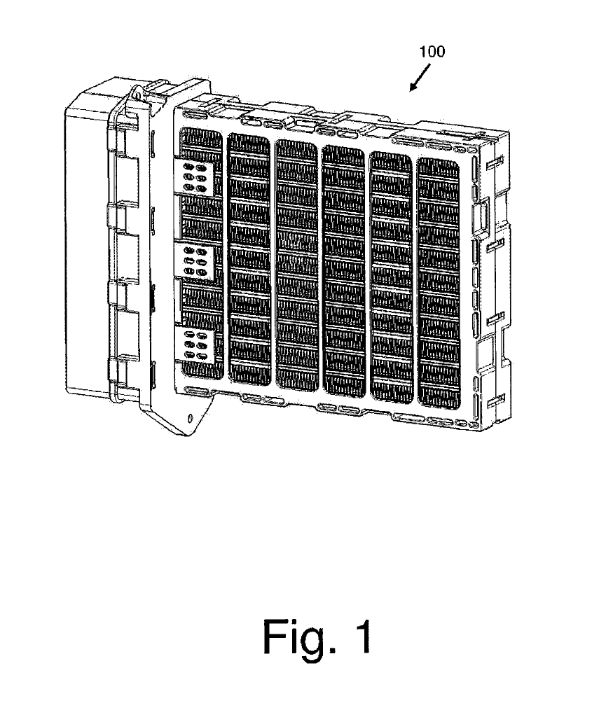

FIG. 1 shows the outer construction of an example of a heating device 100 according to the present invention. As an example, FIG. 1 shows an air heater for the automotive high voltage range with integrated electronic components. The individual heating elements are built into the housing frame shown on the right side of the drawing. The integrated control electronic means are located in the terminal box located on the left.

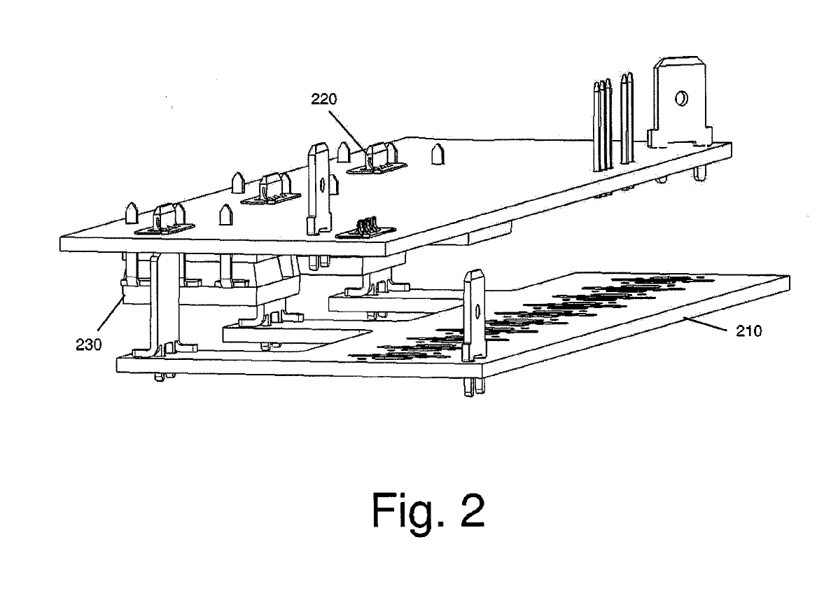

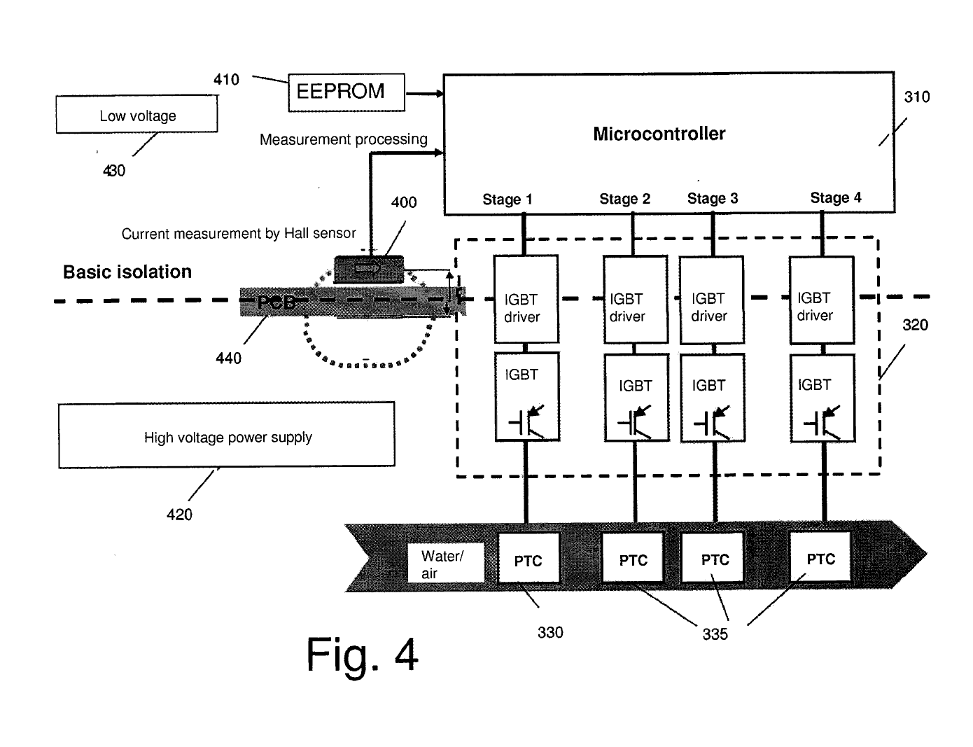

Details of the outer construction of the electronic components are illustrated in FIG. 2. FIG. 2 shows a modular construction of the electronic means in sandwich form in which the various modules are interconnected via a circuit board 210. In particular this refers to the electronic control means 220 and the power switches 230. The electronic control means 220 comprises components for open-loop and closed-loop control according to the present invention. In particular the power switches 230, as constituent parts of the control device according to the invention, are used for the direct adjustment of the heating power by switching a controlled current on and off through the heating elements of a heating stage, the heating elements being respectively assigned to the power switches. Further details of the construction of the electronic means according to an exemplary embodiment are explained in conjunction with FIG. 4.

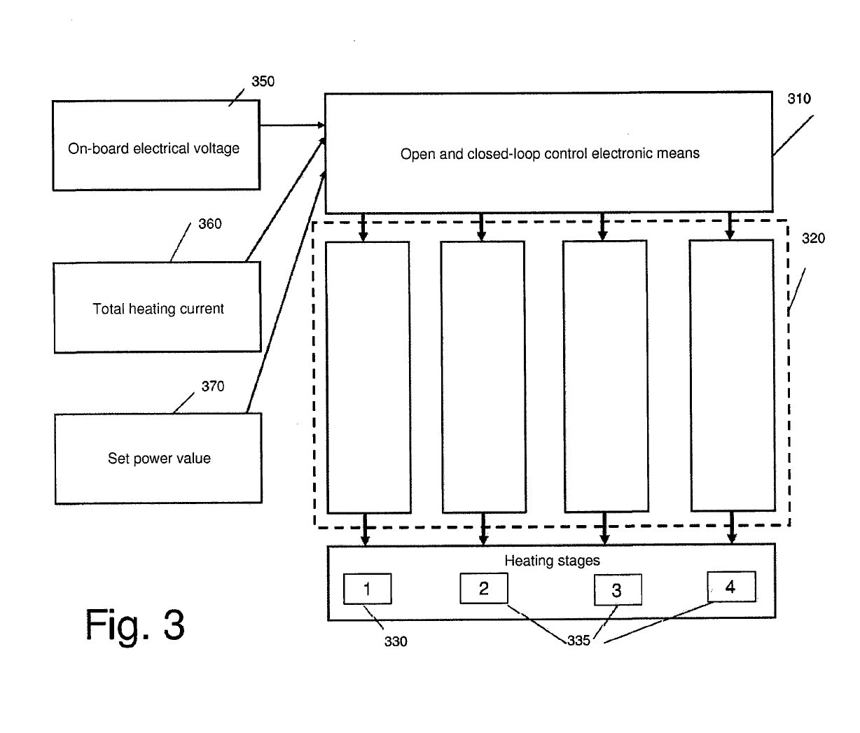

FIG. 3 shows an example of a schematic construction of a heating device according to the present invention. In the illustrated example the heating device comprises four heating stages 1 to 4. The four heating stages comprise a first heating stage 330 and (in the illustrated example three) further heating stages 335. According to the present invention the first heating stage 330 can be controlled continuously or in small steps (quasi-continuously). The other heating stages 335 are binary heating stages, the power of which can be switched between zero and a maximum value only. A group of power switches 320 provides direct control of the heating stages. The power switches are each assigned to one of the heating stages. For the control of the power switches the electronic control means 310 is employed which according to a preferred embodiment is implemented as a microcontroller.

Here, a first adjustment of the heating power can occur according to a power demand assuming nominal conditions for the operating and ambient parameters. Examples of the manufacturer's set nominal conditions are, for example, an on-board electrical voltage of 350 V and the assumption of an air temperature of 0° C. with an air heater. Furthermore, the nominal conditions also include a specified flow velocity (e.g. an air flow rate of 300 kg/h or 10 l/min for a liquid medium). The control parameters required for fulfilling a specified power demand under nominal conditions are laid down by the manufacturer. This can take place, for example, in the form of firmware or software in an EEPROM.

For the adaptation to the operating conditions and changed ambient conditions the power (nominal value) preset in the first step is adapted to the accurate power demand by readjustment. For this purpose a closed-loop control device is integrated into the electronic control means 310, with the aid of which a closed-loop control circuit for the readjustment of the heating power set by the control device is realised. Alternatively, within the scope of the present invention it is also possible to provide the closed-loop control device in separate hardware. For the readjustment the closed-loop control device requires the value of the on-board electrical voltage 350, the specified set value 370 for the power to be consumed by the heating device and the measured value of the total heating current 360. The total heating current includes the value of the current averaged over a cycle frame or a plurality of cycle frames for a heating stage controlled by means of the modulation of the current (e.g. PWM). The averaging can take place by means of software in a microcontroller.

The on-board electrical voltage 350 can here be made available in different ways.

According to a preferred embodiment the on-board electrical voltage can be stored as a fixed value, for example in an EEPROM. In this respect a preliminarily preset nominal value for the on-board electrical voltage is used. An embodiment of this nature can be realised particularly cost-effectively. However, it has the disadvantage that the momentary actual value of the heating power cannot be exactly determined, because deviations of the on-board electrical voltage from the nominal value are not taken into account in operation.

Alternatively, the on-board electrical voltage 350 in the vehicle, on the heating device circuit board, can be directly measured. Thus the disadvantage of the embodiment mentioned above is eliminated, because with each change of the on-board electrical voltage in operation the present value can be provided very quickly. A disadvantage of this embodiment is however the higher costs arising due to the specially provided voltage measurement device on the heater.

A further alternative is possible with the provision as a message from the motor vehicle on-board network via a vehicle bus. The on-board electrical voltage 350 is continuously acquired in the vehicle and made available via the on-board supply system. This embodiment represents in this respect a compromise as it is more economical than the direct measurement, but takes the changes into account more slowly. With this embodiment an updated value of the on-board electrical voltage 350 is available only every 200 to 300 milliseconds (ms).

The closed-loop control device 310 receives the heating power demands 370, for example, from the vehicle on-board network via the vehicle bus (for example LIN or CAN data bus). They can for example be automatically defined such that existing power reserves of the on-board supply system are exploited as completely as possible. They can also be specified by the driver via the air conditioning operating panel.

Alternatively, it is also possible to specify a desired temperature instead of the power demands 370. This may be, for example, a temperature at a certain part of the vehicle, such as an interior compartment temperature or a temperature of the flowing medium. The temperature demand 220 is converted by the control electronic means 220 into a power demand 370.

With the aid of the on-board electrical voltage 350 and the total heating current 360 the consumed power (actual value) is first determined. For this purpose the measured current 360, where necessary suitably averaged over time, for example over one or a plurality of cycle frames, is multiplied with the on-board electrical voltage. The actual value of the total heating power is given according to the equation

P=U×I,

according to which the electrical power P consumed by a component (here: the total of the heating stages of the heating device 100) is equal to the product of the voltage U applied to the component and the total current I flowing through the component. The actual value of the momentary total power of the heating device 100 determined in this way is then compared to the specified power demand (set value) by a comparator implemented in the closed-loop control device. Based on this the control device is initiated to correct the power consumption by an appropriate adaptation of the heating power setting. In a preferred embodiment the new heating power (nominal value) to be set corresponds to the previously set nominal value reduced or increased by the set value deviation. The correction takes place first of all via the setting of the continuous/quasi-continuous first heating stage 330. Depending on the demand the switching of the further binary heating stages 335 on and off can furthermore be included in the correction adaptation of the heating power.

In this way the prescribed nominal value of the heating power is continuously adapted for readjustment in the closed-loop control circuit. By means of this explained concept the heater always accepts a readjustment of the power in the direction of the set value. Through appropriately defined and temporally variable power requirements the readjustment can furthermore also be used to always exploit the maximum power reserves available in the vehicle.

A detailed illustration of the main elements of a controllable heating device according to the invention is shown in FIG. 4. According to the embodiment illustrated in FIG. 4 the heating device comprises a load circuit with a supply voltage in the automotive high voltage range 420 and a control circuit with an operating voltage in the low voltage range 430. Both ranges must be electrically well isolated from one another (basic isolation). Here, the high voltage and low voltage ranges on the PCB (Printed Circuit Board) 440 are in particular isolated from one another. A current measurement (measurement of the total current flowing through the heating device) is in this case, in a particularly simple manner and without affecting the electrical isolation, carried out by electromagnetic means with the aid of a Hall sensor 400 (indirect current measurement).

The microcontroller 310 processes the measurements as well as the fixed values specified in the system, such as the on-board electrical voltage or an assignment table for a quasi-continuous power control of the first heating stage by means of PWM. The EEPROM 410 is illustrated by way of example as a memory device for the system parameters of this nature.

In the present embodiment the group of control elements 320 for each of the heating stages 330, 335 (here represented in each case by a PTC heating element) comprises separately controllable power switches, preferably realised as IGBT (Insulated Gate Bipolar Transistor) power switches. The IGBT power switches operating in the high voltage range are controlled by IGBT drivers which in turn receive their control signals from the microcontroller 310 on the low voltage side. Preferably the switch group 320 with all IGBT drivers and IGBT switching transistors is accommodated in a common housing.

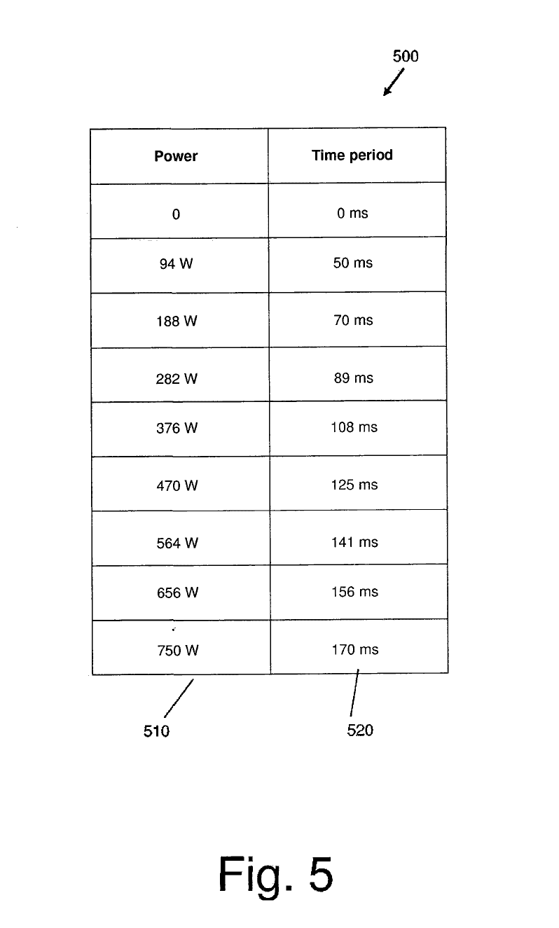

A detailed description of an exemplary open-loop and closed-loop control concept according to the present invention follows. A special exemplary embodiment is explained for the power control of a heating stage controllable in small steps (quasi-continuous) with reference made to the assignment table 500 illustrated in FIG. 5.

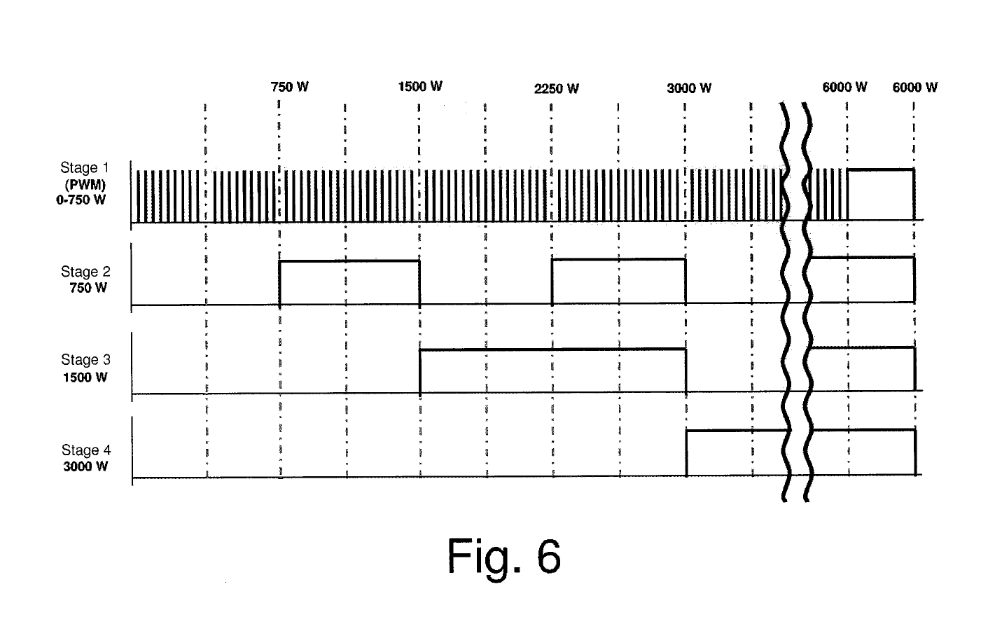

The control occurs using a method which is principally based on PWM (Pulse Width Modulation), but has been modified particularly to facilitate a use of heating elements with a non-linear characteristic, such as for example PTC elements. The maximum power in the example in FIG. 5, 750 W, is here achieved through permanently switching in the first heating stage (refer to Stage 1 in FIG. 6, max. 750 W). This means that the time period of the control is equal to the length of the cycle frame or expressed differently, a mark-space ratio (duty ratio) of 100%. It can also be alternatively achieved through permanently switching in the second, binary heating stage with 750 W of power with the first heating stage switched off. The control concept is further explained below with reference to FIG. 6. In the EEPROM a discrete map is stored with—in the above example of FIG. 5 (for Stage 1 in FIG. 6)—eight power stages.

With a conventional PWM a mark-space ratio proportional to the demanded power is used. If, for example, the power demand is 50% of the maximum power consumed by the heating stage, then a control with a mark-space ratio of 50% is carried out within a fixed cycle frame. A control of this nature (mark-space ratio proportional to the power demand) corresponds to a linear dependence of the power on the mark-space ratio. However this is not present in the automotive high voltage range. In a typical example of PTC heating elements used at approx. 350 V 80% of the nominal power is already achieved under nominal conditions with a mark-space ratio of 40%. The relationship between the mark-space ratio and nominal power can however have a completely different, non-linear progression, as illustrated for example in FIG. 5.

In contrast to the conventional PWM, with the special control concept portrayed here individual power stages and corresponding activation times within a cycle frame are stored as fixed values in the electronic control means of the heating device. According to the preferred embodiment this occurs in the form of a table (assignment table) with a number of pairs of values which on one side specify the power to be set and on the other side the activation duration required for this.

A simple example of an assignment table 500 of this nature is shown in FIG. 5. In the left column 510 the individual controllable power stages (nominal powers corresponding to nominal conditions) are stored as fixed values. As can be taken exemplarily from the listed table 500, in this example the maximum power consumption of the heating stage (with permanent actuation) is 750 W. The range from 0 to 750 W is divided into eight stages so that a finely stepped (quasi-continuous) adjustment of the heating power is possible with steps below 100 watts.

In the right column 520 of table 500 the control times assigned to the respective nominal power stages are stored in milliseconds. The control of the heating stages occurs such that depending on the power demanded the heating stage is activated for the assigned time period by switching on the flow of current at the prevailing on-board electrical voltage. As with conventional PWM, the activation is repeated with a new cycle frame. The length of the permanently specified cycle frame is 170 ms in the present example. The length of the cycle frame is however not important for the invention. Also, completely different cycle frame lengths of, for example, 150 ms or 200 ms or even cycle frames with a completely different order of magnitude are possible.

In this way the relationship between the heating power demand and the stored activation duration per cycle frame in the assignment table can be arranged as required. Thus, the non-linearity of a PTC heating element in the high voltage range can in particular be compensated. For this purpose the corresponding activation times are determined empirically beforehand and stored in the EEPROM 410 by the manufacturer. The nominal powers and the associated empirically determined activation times correspond to defined nominal conditions, i.e. in particular a specified on-board electrical voltage (e.g. 350 V) and a fixed ambient temperature around the heating element (e.g. 0° C.). Due to the previously defined table of values, within the scope of this control no adaptation occurs to currently changing operating parameters and in particular no temperature compensation, which in practice leads to tolerances in the range of about 30% maximum. This disadvantage with the above described simple and robust control of the power stages of a quasi-continuous heating stage is compensated in the scope of the present invention with good approximation due to the continuous readjustment based on a comparison of set and actual values, as described above. Here it is particularly considered that also the deviation of the real ambient conditions as well as other operating parameters such as the on-board electrical voltage and the flow velocity may continuously change from the nominal conditions in real operation.

Normal voltage variations in on-board supply systems in the automotive high voltage range lie in an order of magnitude of 100 V. Electric vehicles have for example a nominal voltage of 350 V. After charging the battery the on-board electrical voltage may rise to approx. 380 V and on discharging drop to approx. 280 V. Electric vehicles with a different nominal voltage on the on-board supply system, for example 400 V also have a corresponding variation. For hybrid vehicles the nominal voltage is approx. 288 V, the maximum on-board electrical voltage is approx. 350 V and the minimum voltage approx. 200 V.

Due to monitoring of the actual heating power applied, the closed-loop control according to the invention can principally also be used in 12 V on-board supply systems. However a voltage variation with 12 V on-board supply systems (for example up to 12.5 V) only plays a minor role for the heating power. Essentially, the current level is decisive (substantially higher than in the automotive high voltage range).

The adjustment of the power stages by the control device therefore occurs on the basis of nominal powers corresponding to nominal conditions. The approximation of the real heating power to the power set value occurs through the readjustment in the closed-loop control circuit. Here, to minimise the difference between the actual and set powers determined by the comparator a nominal power is switched on and off according to the difference.

Within the scope of the control concept explained above it is furthermore also possible to control higher total heating powers in fine steps. For this purpose a combination of a finely stepped controllable first heating stage with further binary heating stages is used as mentioned above in connection with FIGS. 3 and 4.

As an example, the control of power values between 0 and 6000 watts with the aid of such a combination is illustrated in FIG. 6. A total of four heating stages is provided. The first (quasi-continuous) heating stage has in the present example a maximum power consumption of 750 watts. The power consumptions of the binary heating stages are as follows: second heating stage: 750 watts, third heating stage: 1500 watts and the fourth heating stage: 3000 watts.

In the range from 0 to 750 watts a finely stepped control, as described above, is only possible by using the first heating stage. In the following range between 750 watts and 1500 watts (i.e. again a range of 750 watts) the second heating stage is switched on in a binary manner, whereas the first heating stage supplies the fine control within this range according to the above concept. In the following range comprising 750 watts (from 1500 watts to 2250 watts) this occurs analogously with the switching on of the third heating stage, whereby the second heating stage is switched off again. The second and third binary heating stages are switched on simultaneously in the following range between 2250 watts and 3000 watts.

From 3000 watts the fourth heating stage is switch on permanently so that analogously, as described above for the range below 3000 watts, the heating power in the whole range up to 6000 watts can be controlled in fine steps over a total of 64 steps (corresponding to the “points” on a step-by-step linear representation). The number of steps (here: 8 for a single heating stage up to 750 W and 8×8=64 in the total range covering 8×750 W=6000 W) is however only used as an explanatory representation. Preferably more than 50 steps, for example between 50 and 100 steps, are used. However, more than 100 steps and also a substantially greater number of steps is possible, for example approximately 200 steps. The more partial steps are used, the finer is the resolution for the adjustable heating power.

A control concept of this nature means that the PWM cycling is only required in a first heating stage which comprises the smallest power range, whereas in the higher power range a simple binary control occurs. The use of the PWM only occurs for the fine-setting closed-loop control. In this way interference in the high voltage range through EMC emission is largely avoided. The cycling frequencies of the quasi-continuous heating stage are furthermore optimised with regard to the EMC/ripple current. Generally, a finer resolution of the partial steps also causes less interference in the high voltage on-board supply system.

Summarising, the present invention relates to a closed-loop controllable electrical heating device for motor vehicles, in particular with electrical propulsion. Through a readjustment based on a comparison of set and actual values the power is adapted to a specified power demand under continuously changing operating conditions. For this purpose the total current passing through the heating device is measured, for example with a Hall sensor, and the momentary power consumption (actual value) determined by multiplication with the specified on-board electrical voltage.

What is claimed is:

1. An electrical heating device for a motor vehicle the heating device comprising:
a control device for adjusting a heating power by adjusting a heating current flowing through the heating device,
a device for measuring the total heating current; and
a calculation device for calculating a momentary heating power from the measured total heating current and an on-board electrical voltage of the motor vehicle; wherein
the heating power to be adjusted by the control device is readjusted based on the momentary heating power and a set value.

2. An electrical heating device according to claim 1, wherein the device for measuring the total heating current comprises a Hall sensor.

3. An electrical heating device according to claim 1, wherein the heating device comprises a first electrical heating stage with at least one heating element, and wherein the heating power of the first electrical heating stage can be continuously adjusted or adjusted in fine steps by the control device.

4. An electrical heating device according to claim 3, further comprising
at least one further electrical heating stage having at least one heating element;
wherein the heating power of the further electrical heating stage can be switched only between zero and a maximum power; and wherein
the heating power for the electrical heating stages can be separately adjusted by the control device by adjusting the current flowing through each of the electrical heating stages.

5. An electrical heating device according to claim 1, wherein the on-board electrical voltage is transmitted as a message to the heating device through a communication interface of the motor vehicle.

6. An electrical heating device according to claim 5, wherein the communication interface is a vehicle bus.

7. An electrical heating device according to claim 1, wherein the on-board electrical voltage is measured in the heating device.

8. An electrical heating device according to claim 3, wherein
the heating power of the first electrical heating stage can be adjusted in fine steps by modulating the current flowing through the first heating stage;
the heating device further comprises a non-volatile memory for storing an assignment table which assigns a time period for the actuation of the first electrical heating stage to each power stage of a plurality of predetermined power stages; and wherein
the control device for the adjustment of the heating power of the first electrical heating stage activates the current through the first electrical heating stage for the time period assigned to a power stage in the assignment table within a specified cycle frame.

9. An electrical heating device according to claim 8, wherein the dependence between the time periods stored in the assignment table and the power values of the assigned power stages of the first electrical heating stage is non-linear.

10. An electrical heating device according to claim 1, wherein the heating device is suitable for heating fluids.

11. An electrical heating device according to claim 1, further comprising a comparator for determining a deviation of the momentary heating power from the set value;
wherein the readjustment minimizes the deviation of the momentary heating power from the set value.

12. An electrical heating device according to claim 1, wherein the heating elements are PTC heating elements.

13. An electrical heating device according to claim 1, wherein the readjustment is implemented with a microcontroller.

14. A method for the control of an electrical heating device for a motor vehicle in which the heating power is adjusted by adjusting the heating current flowing through the heating device, comprising the steps of
measuring the total heating current;
calculating a momentary heating power from the measured total heating current and an on-board electrical voltage of the motor vehicle; and
readjusting the heating power based on the momentary heating power and a set value.

15. A method according to claim 14, wherein the heating device comprises a first electrical heating stage with at least one heating element, and the wherein step of setting adjusts the first electrical heating stage continuously or in fine steps.
